(19) United States
(12) Patent Application Publication
(10) Pub. No.: US 2026/0228028 A1
(43) Pub. Date: Aug. 6, 2026

(54) PROCESSING MACHINE LEARNING MODELS IN A MACHINE LEARNING PIPELINE USING VIRTUAL RESOURCES AND VAULT-BASED CREDENTIALS

(71) Applicant: Dell Products L.P., Round Rock, TX (US)

(72) Inventors: Shanil Nalakath, Austin, TX (US); Sachin Choyyan Maroli, Liberty Hill, TX (US); Deepu P V, Thiruvananthapuram (IN); Prateek Srivastava, Cedar Park, TX (US)

(21) Appl. No.: 19/047,002

(22) Filed: Feb. 6, 2025

(51) Int. Cl. G06F 9/455; G06F 8/61; G06F 9/50

(52) U.S. Cl. CPC G06F 9/45558; G06F 8/61; G06F 9/5077; G06F 2009/4557

(57) ABSTRACT

Techniques are provided for processing machine learning (ML) models in an ML pipeline using virtual resources and vault-based credentials. One method comprises obtaining a request to process an ML model in a given stage of an ML pipeline; obtaining an ML pipeline template to configure a virtual computing resource; obtaining a namespace that comprises model code for the ML model, artifacts of the ML model and credentials of a user stored in a digital vault; configuring the virtual computing resource using the ML pipeline template and the artifacts; initiating an execution of the model code for the ML model by the configured virtual computing resource, wherein the execution of the model code comprises accessing a protected resource using the credentials obtained from the vault; and obtaining results from the execution of the model code by the configured virtual computing resource.

### BACKGROUND

A number of techniques exist for developing and making changes to machine learning (ML) models. An ML model development platform may enable communication and collaboration among ML professionals. There is a need for a comprehensive repository for accessing ML models and a streamlined workflow for processing ML models.

### SUMMARY

Illustrative embodiments of the disclosure provide techniques for processing ML models in an ML pipeline using virtual resources and vault-based credentials. One method includes obtaining a request from a user to process at least one ML model in a given stage of a plurality of stages of an ML pipeline; obtaining an ML pipeline template to configure at least one virtual computing resource; obtaining a namespace associated with the user, wherein the namespace comprises model code for the at least one ML model, at least one artifact of the at least one ML model and one or more credentials of the user stored in a secure digital vault; configuring the at least one virtual computing resource using the ML pipeline template and the at least one artifact of the at least one ML model; initiating an execution of at least a portion of the model code for the at least one ML model by the configured at least one virtual computing resource, wherein the execution of the model code for the at least one ML model comprises accessing at least one protected resource using at least one of the one or more credentials of the user obtained from the vault; obtaining one or more results from the execution of the at least the portion of the model code for the at least one ML model by the configured at least one virtual computing resource; and initiating one or more processing steps based at least in part on at least one of the one or more results.

Illustrative embodiments can provide significant advantages relative to conventional techniques. For example, technical problems related to such conventional techniques are mitigated in one or more embodiments by executing at least one ML model using at least one virtual computing resource that is configured using one or more ML pipeline templates and at least one artifact associated with the at least one ML model.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for processing ML models in an ML pipeline using virtual resources and vault-based credentials in an illustrative embodiment;

FIG. 2 shows an example of an ML model lifecycle in an illustrative embodiment;

FIG. 3 illustrates an ML model development system configured for processing of ML models in an ML pipeline in an illustrative embodiment;

FIG. 4 illustrates the namespace and vault management engine of FIG. 3 in further detail in an illustrative embodiment;

FIG. 5 illustrates a user configuring an ML pipeline in an illustrative embodiment;

FIG. 6 illustrates an execution of ML models in a virtual environment that is configured using one or more ML pipeline templates, as well as model-specific artifacts and package requirements, in an illustrative embodiment;

FIG. 7 illustrates a configuration and execution of ML models using one or more workflow pods to provide batch-based predictions and real-time predictions in an illustrative embodiment;

FIG. 8 illustrates an execution of ML models in at least one container that is configured using one or more ML pipeline templates, as well as model-specific artifacts and package requirements, in an illustrative embodiment;

FIG. 9 illustrates an architecture for parallel training and prediction using multiple model instances in an illustrative embodiment;

FIG. 10 is a flow chart illustrating an exemplary implementation of a method for processing ML models in an ML pipeline using virtual resources and vault-based credentials in an illustrative embodiment;

FIG. 11 illustrates an exemplary processing platform that may be used to implement at least a portion of one or more embodiments of the disclosure comprising a cloud infrastructure; and

FIG. 12 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for processing ML (ML) models in an ML pipeline using virtual resources and vault-based credentials.

The term MLOps generally refers to a set of practices that combines ML model development and information technology (IT) operations. One or more aspects of the disclosure recognize that MLOps may be used to shorten the ML model development lifecycle and to provide continuous model integration, continuous model delivery, and continuous model deployment. Continuous model integration generally allows model development teams to merge and verify changes more often by automating model generation (e.g., converting ML source code files into standalone software components that can be executed on a computing device) and model tests, so that errors can be detected and resolved early. Continuous model delivery extends continuous model integration and includes efficiently and safely deploying the changes into model testing and production environments. Continuous model deployment allows model code changes that pass an automated testing phase to be automatically released into a production (e.g., prediction) environment, thus making the changes visible to end users. Such processes are typically executed within an ML pipeline.

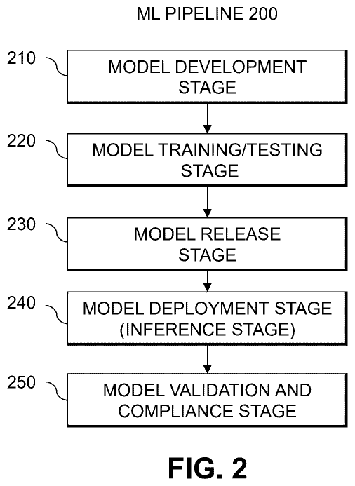

MLOps solutions typically employ blueprints that encompass continuous model integration, continuous model testing, continuous model deployment (also referred to as continuous model development) and/or continuous model change and management abilities. MLOps blueprints allow development teams to efficiently innovate by automating workflows for a model development and delivery lifecycle. A typical model development lifecycle is discussed further below in conjunction with FIG. 2.

An ML pipeline automates a model delivery process and typically comprises a set of automated processes and tools that allow model developers and an operations team to work together to generate and deploy model code to a production environment. A preconfigured ML pipeline may comprise a specified set of elements and/or environments. Such elements and/or environments may be added or removed from the ML pipeline, for example, based at least in part on the model and/or compliance requirements. An ML pipeline typically comprises one or more quality control gates to ensure that model code does not get released to a production environment without satisfying a number of predefined testing and/or quality requirements. For example, a quality control gate may specify that model code should compile without errors or failures and that all unit tests and functional user interface tests must pass.

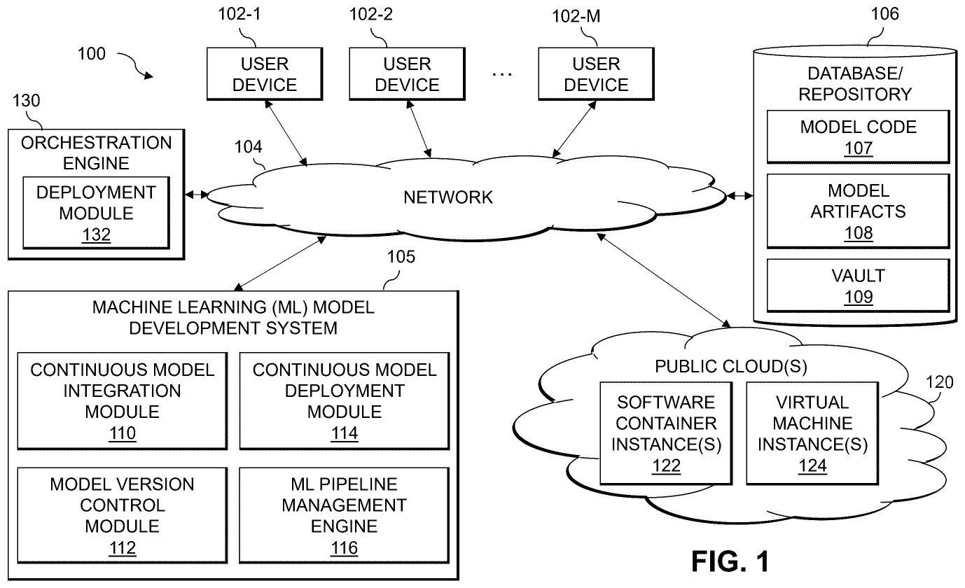

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 may be employed, for example, by model developers and other MLOps professionals to perform, for example, model development and/or model deployment tasks. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is an ML model development system 105 and an orchestration engine 130.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

The ML model development system 105 comprises a continuous model integration module 110, a model version control module 112, a continuous model deployment module 114 and an ML pipeline management engine 116. Exemplary processes utilizing elements 110, 112, 114 and/or 116 will be described in more detail with reference to, for example, the flow diagrams of FIGS. 2 through 5 and 10.

In at least some embodiments, the continuous model integration module 110, the model version control module 112, the continuous model deployment module 114 and/or the ml pipeline management engine 116, or portions thereof, may be implemented using functionality provided, for example, by commercially available MLOps and/or model development and deployment tools, such as the GitLab development platform, the GitHub development platform, the Azure MLOps server and/or the Bitbucket CI/CD tool, or another Git-based MLOps and/or model development and deployment tool. The continuous model integration module 110, the model version control module 112 and the continuous model deployment module 114 may be configured, for example, to perform model development and deployment tasks and to provide access to MLOps tools and/or repositories. The continuous model integration module 110 provides functionality for automating the integration of model code changes from multiple model developers or other MLOps professionals into a single model project.

In one or more embodiments, the model version control module 112 manages canonical schemas (e.g., ML pipeline blueprints, ML pipeline templates, and ML pipeline scripts for jobs) and other aspects of the repository composition available from the MLOps and/or model development and deployment tool. Source code management (SCM) techniques may be used to track modifications to a model source code repository. In some embodiments, SCM techniques are employed to track a history of changes to a model code base and to resolve conflicts when merging updates from multiple model developers.

The continuous model deployment module 114 manages the automatic release of model code changes made by one or more model developers from a model repository to a production environment, for example, after validating the stages of production have been completed.

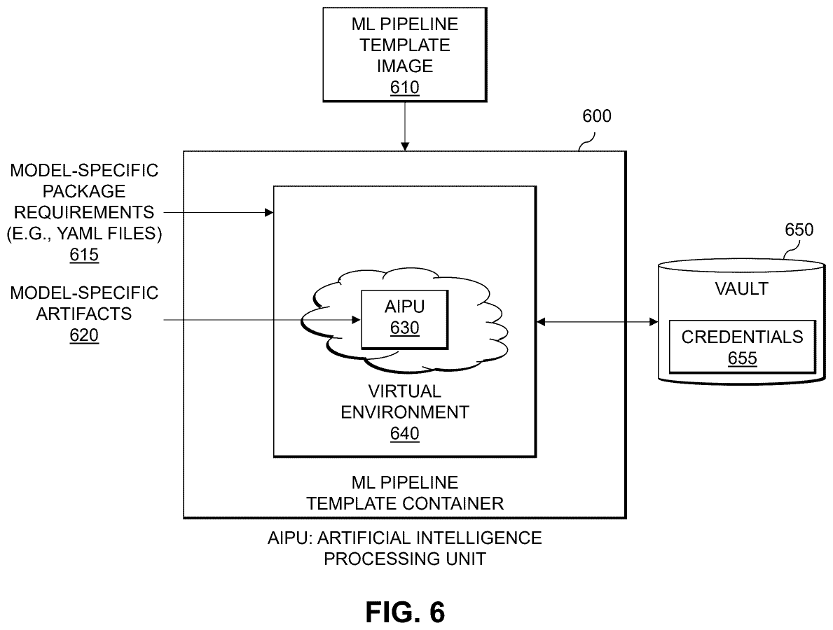

In at least some embodiments, the ML pipeline management engine 116 may implement at least portions of the disclosed techniques for processing ML models in an ML pipeline using virtual resources and vault-based credentials, as discussed further below in conjunction with, for example, FIGS. 6 through 9.

It is to be appreciated that this particular arrangement of elements 110, 112, 114 and/or 116 illustrated in the ML model development system 105 of the FIG. 1 embodiment is presented by way of example only, and alternative arrangements can be used in other embodiments. For example, the functionality associated with the elements 110, 112, 114 and/or 116 in other embodiments can be combined into a single module, or separated across a larger number of modules. As another example, multiple distinct processors can be used to implement different ones of the elements 110, 112, 114 and/or 116 or portions thereof.

At least portions of elements 110, 112, 114 and/or 116 may be implemented at least in part in the form of software that is stored in memory and executed by a processor.

In at least some embodiments, the orchestration engine 130 may be implemented, at least in part, using, for example, the functionality of Kubernetes. The orchestration engine 130 may employ a deployment module 132 to deploy one or more virtual resources to a public cloud, for example, such as public cloud 120. As shown in FIG. 1, the deployed virtual resources may comprise one or more software container instances 122 and/or one or more virtual machine instances 124.

In one or more embodiments, the orchestration engine 130 may create execution environments using containers that provide a form of operating system virtualization. One container might be used to run a small microservice or a software process, as well as larger applications. The container provides the necessary executables, binary code, libraries, and configuration files. In some embodiments, the orchestration engine 130 may employ a PKS cluster (e.g., an enterprise Kubernetes platform) that enables developers to provision, operate and/or manage enterprise-level Kubernetes clusters to execute an ML pipeline job. The Docker open-source containerization platform may be leveraged in some embodiments for building, deploying, and/or managing containerized applications. Docker enables developers to package applications into container-standardized executable components that combine model source code with operating system libraries and dependencies required to run that code in any environment.

Additionally, the ML model development system 105 can have at least one associated database 106 (e.g., at least partially implemented as a repository) configured to store data pertaining to, for example, model code 107 of at least one ML model, one or more model artifacts 108 and a vault 109 (e.g., a secure digital vault). The artifacts may comprise a file or output generated during a model training process (e.g., the fully trained model). In addition, the artifacts may comprise training logs, model hyperparameters, model checkpoints, data processing details and/or other data created in the ML pipeline. ML engineers can modularize the model code 107 according to a defined ML pipeline, as discussed further below in conjunction with FIG. 2, and can commit the model code 107 a source control repository associated with database 106. for example.

For example, at least a portion of the at least one associated database 106 may correspond to at least one code repository that stores the model code 107. In such an example, the at least one code repository may include different snapshots or versions of the model code 107, at least some of which can correspond to different branches of the model code 107 used for different development environments (e.g., one or more testing environments, one or more training environments, and/or one or more deployment environments).

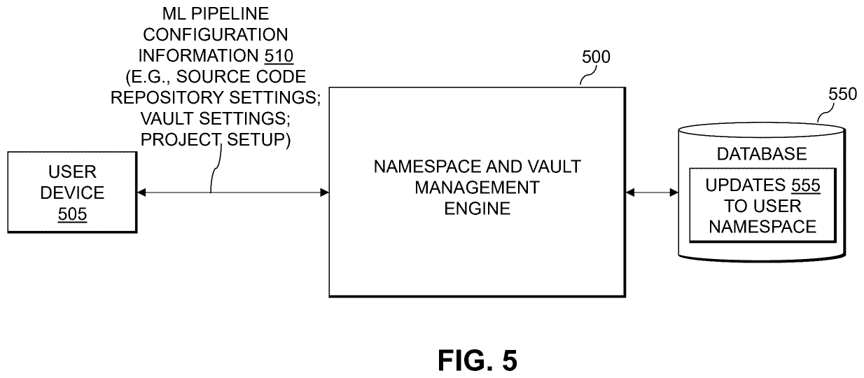

Also, at least a portion of the one or more user devices 102 can also have at least one associated database (not explicitly shown in FIG. 1). As an example, such a database can maintain a particular branch of the model code 107 that is developed in a sandbox environment associated with a given one of the user devices 102, as discussed further below in conjunction with FIG. 5. Any changes associated with that particular branch can then be sent and merged with branches of the model code 107 maintained in the at least one database 106, for example.

An example database 106, such as depicted in the present embodiment, can be implemented using one or more storage systems associated with the ML model development system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the ML model development system 105 are one or more input-output devices, which illustratively comprise keyboards, displays or other types of input-output devices in any combination. Such input-output devices can be used, for example, to support one or more user interfaces to the ML model development system 105, as well as to support communication between ML model development system 105 and other related systems and devices not explicitly shown.

Additionally, the ML model development system 105 and/or the orchestration engine 130 in the FIG. 1 embodiment are assumed to be implemented using at least one processing device. Each such processing device generally comprises at least one processor and an associated memory, and implements one or more functional modules for controlling certain features of the ML model development system 105 and/or the orchestration engine 130.

More particularly, the ML model development system 105 and/or the orchestration engine 130 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows the ML model development system 105 and/or the orchestration engine 130 to communicate over the network 104 with the user devices 102, and illustratively comprises one or more conventional transceivers.

It is to be understood that the particular set of elements shown in FIG. 1 for ML model development system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the ML model development system 105 and database(s) 106 can be on and/or part of the same processing platform.

FIG. 2 shows an example of an ML pipeline 200 (sometimes referred to as an ML model lifecycle) in an illustrative embodiment. An ML pipeline typically comprises several components, such as data collection, data verification, resource management, service infrastructure, feature engineering, model analysis, process management tools, configuration and/or monitoring, in one or more stages of the ML pipeline 200.

In the example of FIG. 2, the ML pipeline 200 is comprised of stages 210 through 250. A model development stage 210 comprises generating (e.g., writing) the model code for a given ML model. A model training and testing stage 220 tests the model code. A model release stage 230 comprises delivering the model code to a repository. A model deployment stage 240 comprises deploying the model code to a production environment (e.g., to make predictions). Finally, a model validation and compliance stage 250 comprises steps to validate a model deployment, for example, based at least in part on the needs of a given organization. For example, image security scanning tools may be employed to ensure a quality of the deployed images by comparing them to known vulnerabilities, such as those known vulnerabilities in a catalog of common vulnerabilities and exposures (CVEs).

In one or more embodiments, an ML pipeline can comprise one or more of the following elements: (i) local development environments (e.g., the computers of individual developers); (ii) a continuous model integration server (or a model development server); (iii) one or more test servers (e.g., for functional user interface testing of the models); and (iv) a model production environment. The ML pipelines may be defined, for example, in YAML (Yet Another Markup Language) with a set of commands executed in series to perform the necessary activities (e.g., the steps of each pipeline activity). An ML pipeline 200 can be triggered on-demand or scheduled to run at defined intervals, for example.

An ML engineer can provide an ML project file, for example, by converting a GIT-based project to an ML project by adding, for example, an ML project file (adding all training dependencies, for example, in a related configuration file to allow training, for example, to be performed anywhere). The model training of stage 220 can thus be triggered from anywhere, when the ML project file and related configuration file are available. The model testing of stage 220 can be tracked and logged (including, e.g., parameters and metrics). Model wrapper classes may be employed with designated pre-processing and/or post-processing steps, and optionally extended to any ML library.

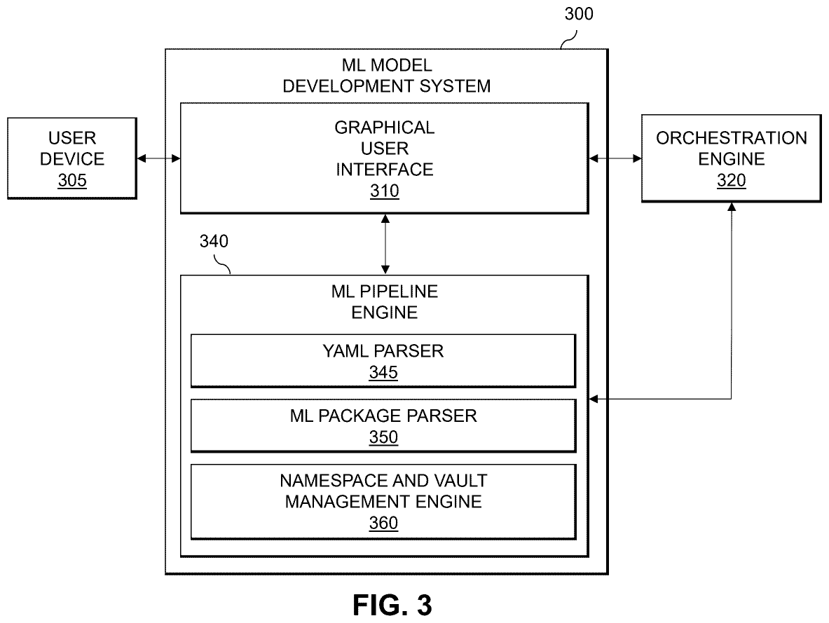

FIG. 3 illustrates an ML model development system 300 configured for processing of ML models in an ML pipeline, in accordance with an illustrative embodiment. In the example of FIG. 3, the ML model development system 300 comprises a graphical user interface (GUI) 310 and an ML pipeline engine 340.

In addition, in at least some embodiments, a user employing a user device 305 utilizes the GUI 310 to interact with the ML model development system 300, such as one or more visual representations of an ML pipeline or components thereof (e.g., pipeline jobs). Generally, the GUI 310 provides access to, for example, a visual ML pipeline editor, a pipeline manager, an MLOps toolkit and a reusable resource library, for example.

In some embodiments, the GUI 310 allows ML engineers to configure ML models using a visual interface and to specify the ML pipeline stages that need to be executed (e.g., training, validation or prediction).

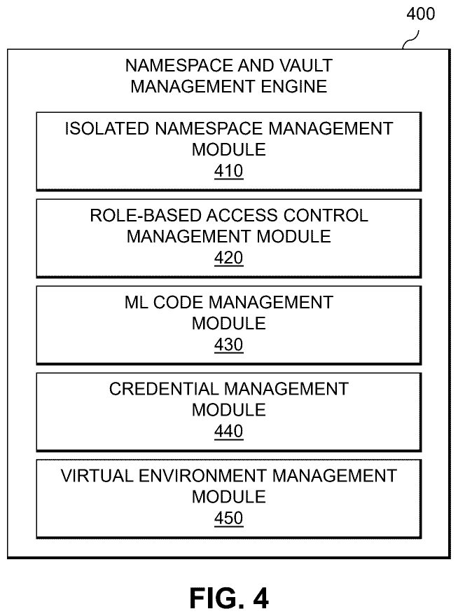

As shown in FIG. 3, the exemplary ML pipeline engine 340 comprises a YAML parser 345, an ML package parser 350 and a namespace and vault management engine 360. The YAML parser 345 processes top-level YAML files obtained from one or more MLOps collaboration tools, for example, for conversion into a renderable format, such as a JSON (JavaScript Object Notation) file format. The ML package parser 350 processes YAML-based model-specific package requirement files, for example. The namespace and vault management engine 360 is employed to interact with the user device 305 to process ML pipeline configuration information and to make appropriate updates to a user namespace, as discussed further below in conjunction with FIGS. 4 and 5.

In the example of FIG. 3, the GUI 310 interacts with the exemplary ML pipeline engine 340 and the orchestration engine 320, and the exemplary ML pipeline engine 340 and the orchestration engine 320 also interact with one another, in order to process one or more ML pipelines (e.g., to automatically resolve one or more pipeline failures).

In one or more embodiments, the graphical user interface may present a visual representation of at least some of the plurality of stages of the ML pipeline 200 to a user for selection of a given ML model to process.

FIG. 4 illustrates the namespace and vault management engine of FIG. 3 in further detail in accordance with an illustrative embodiment. In the example of FIG. 4, the namespace and vault management engine 400 comprises an isolated namespace management module 410, a role-based access control (RBAC) management module 420, an ML code management module 430, a credential management module 440 and a virtual environment management module 450.

In at least some embodiments, the isolated namespace management module 410 ensures that a given namespace may only be accessed by authorized users and applications, for example. A given user may specify, for example, who can access a namespace of the given user (such as members of a given team or project).

In one or more embodiments, the RBAC management module 420 may implement RBAC techniques to restrict access to systems and protected resources. The ML code management module 430 may coordinate the development, storage and processing of ML code. RBAC can be configured at the namespace level, in some embodiments, to define fine-grained permissions for users and service accounts (ensuring, for example, that only authorized entities can access or modify resources within a namespace, maintaining strict access control).

In at least some embodiments, the credential management module 440 manages the storage of credentials in a vault, for example, and the access of such credentials stored in the vault (e.g., by calls from ML code). The virtual environment management module 450 may manage the virtual environment and interact with the orchestration engine 130, for example, to launch virtual resources (e.g., one or more software container instances 122 and/or one or more virtual machine instances 124) in the public cloud 120, as needed.

Exemplary processes utilizing elements 410, 420, 430, 440 and/or 450 will be described in more detail with reference to, for example, the flow diagrams of FIGS. 6 through 9. It is to be appreciated that this particular arrangement of elements 410, 420, 430, 440 and/or 450 illustrated in the namespace and vault management engine 400 of the FIG. 4 embodiment is presented by way of example only, and alternative arrangements can be used in other embodiments. For example, the functionality associated with the elements 410, 420, 430, 440 and/or 450 in other embodiments can be combined into a single module, or separated across a larger number of modules. As another example, multiple distinct processors can be used to implement different ones of the elements 410, 420, 430, 440 and/or 450 or portions thereof. At least portions of elements 410, 420, 430, 440 and/or 450 may be implemented at least in part in the form of software that is stored in memory and executed by a processor.

FIG. 5 illustrates a user configuring an ML pipeline in an illustrative embodiment. In the example of FIG. 5, a user of a user device 505 provides ML pipeline configuration information 510 (e.g., source code repository settings, vault settings and/or project setup information). The namespace and vault management engine 500 (e.g., implemented as discussed above in conjunction with FIGS. 3 and/or 4) processes the provided ML pipeline configuration information 510 and makes appropriate updates 555 to a user namespace associated with the user stored in database 550.

In at least some embodiments, a user namespace may comprise software code for at least one ML model, at least one artifact (e.g., training data embedded with the model) of the at least one ML model and one or more credentials of the user stored in a secure digital vault.

FIG. 6 illustrates an execution of ML models in a virtual environment that is configured using one or more ML pipeline templates, as well as model-specific artifacts and package requirements, in an illustrative embodiment. In the example of FIG. 6, an ML pipeline template container 600 comprises at least one virtual environment 640 comprising one or more artificial intelligence processing units (AIPUs) 630. The at least one virtual environment 640 may be configured using an ML pipeline template image 610 (e.g., that defines generic containers for processing ML models), model-specific package requirements 615 (e.g., YAML files) and model-specific artifacts 620 (e.g., that customizes the generic container template using model-specific ML code). ML pipeline template image 610 may employ an environment and package dependency management platform. The model-specific package requirements 615 may identify one or more software dependencies to be installed for an execution of at least a portion of software code associated with at least one ML model. The model-specific artifacts 620 may comprise the trained model with metadata (e.g., training data embedded with the model).

The configured virtual environment 640 may execute at least a portion of the software code for at least one ML model. The execution of the software code for the at least one ML model may comprise accessing at least one protected resource (e.g., a database) using one or more credentials 655 of the user obtained from a vault 650 (e.g., a secure digital vault).

Thus, in some embodiments, the disclosed ML model processing framework provides an infrastructure to train and deploy ML models.

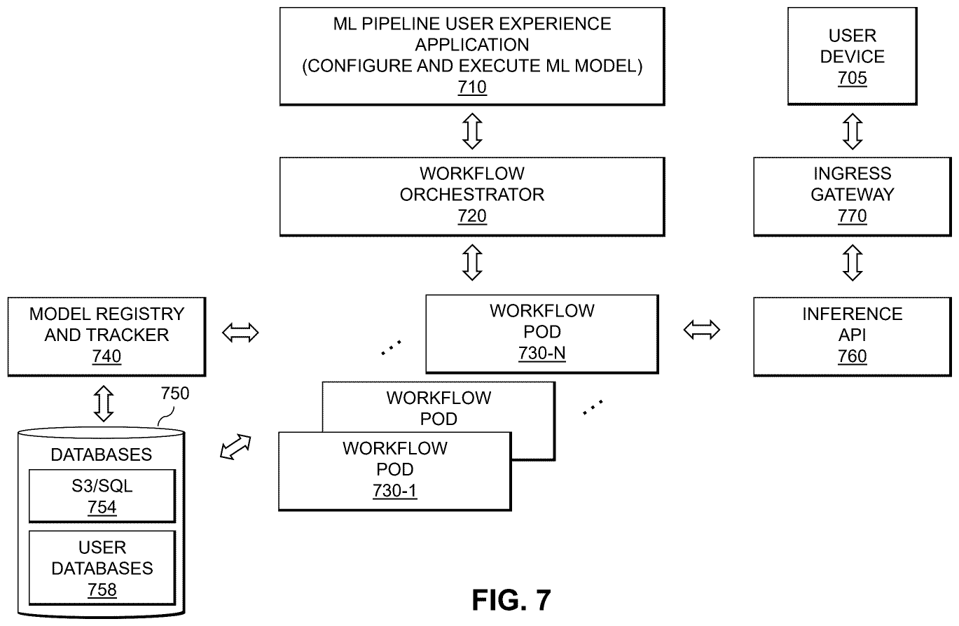

FIG. 7 illustrates a configuration and execution of ML models using one or more workflow pods to provide batch-based predictions and real-time predictions in an illustrative embodiment. In the example of FIG. 7, an ML pipeline user experience application 710 may be employed to configure and/or execute one or more ML models. When a user initiates an execution of an ML model, for example, the request may specify data to be applied to model. In response to the user request, a workflow orchestrator 720 will launch one or more containers to execute the ML model in one or more workflow pods 730-1 through 730-N (collectively, workflow pods 730).

In some embodiments, the workflow orchestrator 720 enables the execution of different workflow steps as a chain of containers in sequential, parallel and/or cyclic patterns, as defined, for example, by an ML engineer. ML engineers can execute different stages in the ML pipeline 200, as required, and the workflow orchestrator 720 will create the appropriate workflow based on the user action.

As the ML model executes in the workflow pods 730, experimental results and model metrics, for example, are provided to a model registry and tracker 740 that maintains a listing of model versions with corresponding model information. In addition, the model code may request data (e.g., training data or inference data) from one or more databases 750, such as S3 and/or SQL databases 754 and user databases 758. The database requests may require different credentials obtained from the vault to access the S3 and/or SQL databases 754 and/or user databases 758.

In addition, in a batch prediction mode, predictions generated by the executing ML model may be stored in one or more of the S3 and/or SQL databases 754 and/or user databases 758. Typically, in a batch prediction mode, numerous inputs are collected over time and then the ML model may be dynamically created to perform the predictions in batches (and then the ML models may be discarded). The batch prediction mode may employ, for example, a serverless computing service that executes code in response to events.

In a real-time (e.g., live) prediction mode, predictions may be provided to a user of a user device 705 using an inference API (application programming interface) 760 and an ingress gateway 770 (e.g., a load balancer). In a real-time (e.g., live) prediction mode, the model is deployed and accessed, for example, as an API or can be offered to cloud infrastructure tenants or other system users using a model-as-a-service model. The inference API 760 provides a mechanism for the ML model to make predictions on new data.

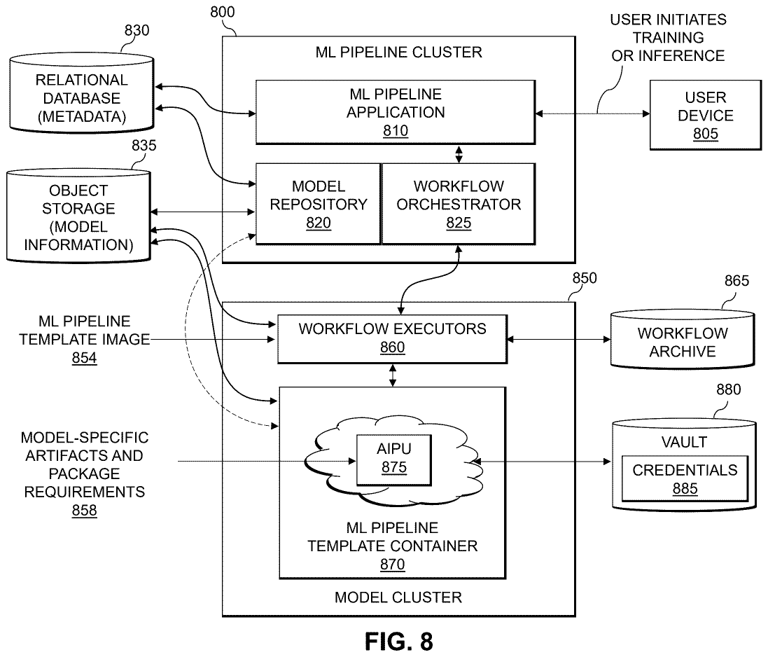

FIG. 8 illustrates an execution of ML models in at least one container that is configured using one or more ML pipeline templates, as well as model-specific artifacts and package requirements, in an illustrative embodiment. In the example of FIG. 8, an ML pipeline cluster 800 executes one or more ML pipeline applications 810 that interact with a user device 805 to process user requests, for example, to initiate model training and/or model inference.

In response to a user request, the workflow orchestrator 825 will launch one or more containers in a model cluster 850 to execute an ML model associated with the user request in an ML pipeline template container (or another virtual computing resource). The ML pipeline template container 870 comprises one or more AIPUs 875. The ML pipeline template container 870 may be configured using an ML pipeline template image 854 (e.g., that defines generic containers for processing ML models) that is passed to one or more workflow executors 860, and model-specific artifacts and package requirements 858 that customize the generic container template using model-specific ML code, as discussed above in conjunction with FIG. 6. The model-specific package requirements may identify one or more software dependencies to be installed for an execution of at least a portion of software code associated with at least one ML model. The model-specific artifacts may comprise the trained model with metadata (e.g., training data embedded with the model).

By creating logical partitions within the model cluster 850, namespaces ensure that resources, such as pods, services and secrets are isolated. In this manner, unauthorized access and/or interference between different applications or teams is prevented, to enhance data privacy.

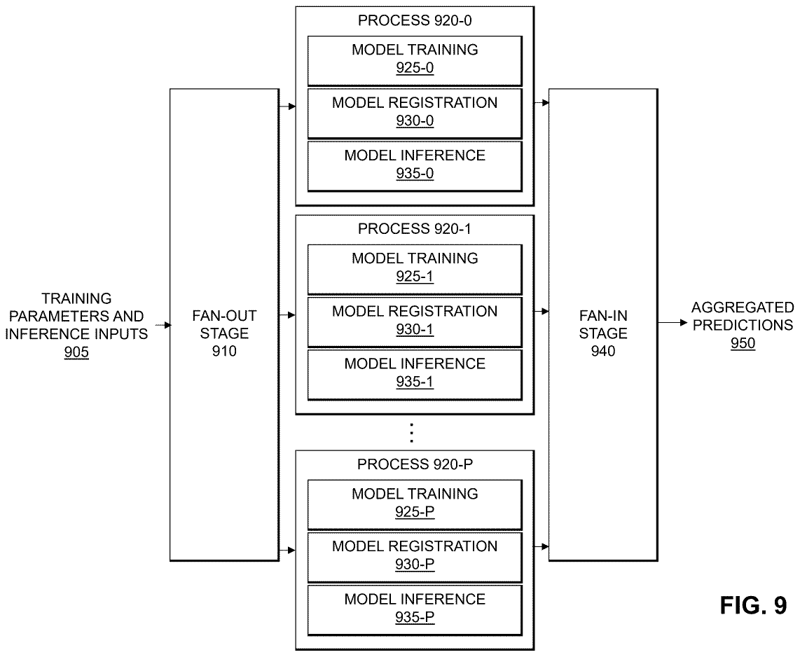

As shown in FIG. 8, the ML pipeline cluster 800 further comprises a model repository 820, that stores one or more ML models, and a workflow orchestrator 825. A relational database (e.g., a SQL server) 830 stores metadata required for the ML pipeline as well as metadata required for model training and execution. An object storage (e.g., an S3 cloud object store) 835 stores model information, such as model artifacts from the model repository 820; environment archives from the workflow executors 860 (e.g., improving the workflow execution by avoiding the need to create the environment in each container in real-time); configuration files from the workflow executors 860 defining packages required for model training and execution; workflow logs and fan-out inputs, as discussed further below in conjunction with FIG. 9, from the workflow executors 860.

In addition, the ML pipeline template container 870 provides model metadata to the model repository 820, as well as trained and registered models to the object storage 835.

During the execution of the ML model, one or more parameters associated with the execution may be recorded in a workflow archive 865. The ML pipeline template container 870 may execute at least a portion of software code associated with at least one ML model. The execution of the software code associated with the at least one ML model may comprise accessing at least one protected resource (e.g., a database) using one or more credentials 885 of the user obtained from a vault 880 (e.g., a secure digital vault). Model execution, model prediction and model inference, for example, may require different types of secrets and/or environment variables from the vault 880.

FIG. 9 illustrates an architecture for parallel training and prediction using multiple model instances in an illustrative embodiment. In the example of FIG. 9, training parameters and inference inputs 905 are applied to a fan-out stage 910 specified in the ML code that distributes the training parameters and inference inputs 905 to a plurality of parallel processes 920-0 through 920-P. The training parameters may specify, for example, a desired number of parallel processes 920 and/or a type of computing resources to be used for training, such as CPUs or GPUs, for example.

The disclosed parallel training techniques improve efficiency by accelerating the learning performance. Further, the disclosed containerization techniques allow each container to be executed as a different system, thereby allowing the training to be scaled up with a desired number of parallel processes 920. Further, the appropriate number of containers can be automatically instantiated to support the specified number of parallel processes 920.

The parallel processes 920-0 through 920-P each comprise (i) respective model training stages 925-0 through 925-P; (ii) respective model registration stages 930-0 through 930-P; and (iii) respective model inference stages 930-0 through 930-P.

In a model training phase, the training data may be provided by the fan-out stage 910 to each of the model training stages 925 for parallel training. For example, each of the parallel processes 920 (e.g., each model instance) may be associated with a different country or region. Thus, a particular model instance may be trained in the respective model training stage 925 using, for example, training data from the associated country or region (or training data from similar countries or regions). In other implementations, each of the parallel processes 920 (e.g., each model instance) may be associated with a different product or season (or another time period).

The disclosed parallel training techniques allow an ML engineer to perform all of the training at the same time. For example, if one or more servers can be instantiated to perform each of the parallel processes 920 at the same time.

Following the training of each model instance, the trained models are registered by the respective model registration stages 930, for example, in a model registry stored by the object storage 835.

In a model inference phase, the inference (e.g., input) data (e.g., runtime data from the associated country or region) may be provided by the fan-out stage 910 to each of the model inference stages 935 for generating parallel predictions. Thus, the respective trained model instances generate a respective prediction using a respective set of inference data. The predictions from each of the model inference stages 935 may be aggregated by a fan-in stage 940 specified in the ML code to provide one or more aggregated predictions 950.

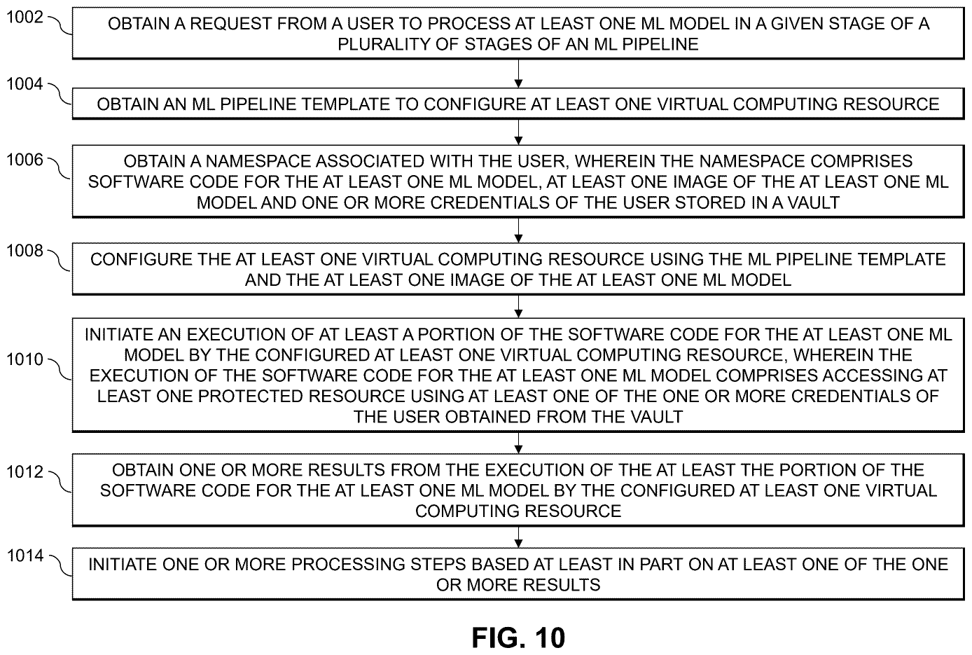

FIG. 10 is a flow chart illustrating an exemplary implementation of a method for processing ML models in an ML pipeline using virtual resources and vault-based credentials, in accordance with an illustrative embodiment. In the example of FIG. 10, a request from a user to process at least one ML model in a given stage of a plurality of stages of an ML pipeline is obtained in step 1002. AN ML pipeline template to configure at least one virtual computing resource is obtained in step 1004. A namespace associated with the user is obtained in step 1006, where the namespace comprises model code for the at least one ML model, at least one artifact of the at least one ML model and one or more credentials of the user stored in a secure digital vault.

The at least one virtual computing resource is configured in step 1008 using the ML pipeline template and the at least one artifact of the at least one ML model. An execution of at least a portion of the model code for the at least one ML model is initiated in step 1010 by the configured at least one virtual computing resource, wherein the execution of the model code for the at least one ML model comprises accessing at least one protected resource using at least one of the one or more credentials of the user obtained from the secure digital vault. One or more results from the execution of the at least the portion of the model code for the at least one ML model by the configured at least one virtual computing resource is obtained in step 1012. One or more processing steps are initiated in step 1014 based at least in part on at least one of the one or more results.

It is to be understood that the term “namespace,” as used herein, shall be broadly construed to encompass any set of names, identifiers or other labelling information that identify and/or organize services and/or other objects in a computing environment, as would be apparent to a person of ordinary skill in the art. In some embodiments, a given user namespace may identify, organize and/or provide access to software code, images and/or credentials associated with ML models for the given user. For example, a namespace may be implemented as a directory in some embodiments comprising a hierarchical collection of service names and object names. A namespace may be a portion of a larger namespace or a combination of smaller namespaces. It should further be appreciated that “generating” a namespace may encompass, for example, populating an existing or previously-created namespace with one or more service names and/or object names.

In one or more embodiments, the process of FIG. 10 further comprises providing a graphical user interface to present a visual representation of at least some of the plurality of stages of the ML pipeline to the user for selection of a given ML model to execute. The process of FIG. 10 may also, or alternatively, comprise (i) initiating a debugging of at least a portion of the at least one ML model using the one or more results from the execution of the at least the portion of the model code for the at least one ML model; (ii) processing at least one configuration file associated with the at least one ML model to identify one or more software dependencies for an execution of the at least the portion of the model code for the at least one ML model; and installing the one or more identified software dependencies for the execution of the at least the portion of the model code on the configured at least one virtual computing resource; and/or (iii) obtaining configuration information for the ML pipeline from the user and updating at least a portion of the namespace associated with the user using the obtained configuration information.

In at least one embodiment, the obtaining the one or more results from the execution of the at least the portion of the model code for the at least one ML model further comprises one or more of: providing the one or more results to the user in a first execution mode and storing the one or more results in at least one database in a second execution mode. The request may specify data to be applied to the at least one ML model during the execution of the at least the portion of the model code for the at least one ML model by the configured at least one virtual computing resource. The request from the user to process the at least one ML model may comprise one or more of a request to train the at least one ML model and a request for the at least one ML model to generate one or more predictions. The ML pipeline template may define a generic configuration of the at least one virtual computing resource and wherein the at least one artifact of the at least one ML model comprises model-specific modifications to the generic configuration of the at least one virtual computing resource.

In some embodiments, the process of FIG. 10 may further comprise implementing a plurality of the configured at least one virtual computing resource in parallel, and wherein a given instance of the at least one ML model is trained on a given configured virtual computing resource using a respective set of training data to generate a respective trained ML model that generates a respective prediction using a respective set of inference data. The respective predictions from the plurality of trained ML models may be aggregated into an aggregate prediction.

The particular processing operations and other network functionality described in conjunction with the flow diagrams of FIGS. 2 and 10, for example, are presented by way of illustrative example only, and should not be construed as limiting the scope of the disclosure in any way. Alternative embodiments can use other types of processing operations to provide functionality for processing ML models in an ML pipeline using virtual resources and vault-based credentials. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

In one or more embodiments, the disclosed techniques for ML pipeline processing provide a flexible and iterative approach to processing ML models that can adapt to changing business requirements over time. An ML model processing framework is provided that employs a centralized code repository, a streamlined workflow and a centralized platform in at least some embodiments to process ML models. The disclosed ML model processing framework, in some embodiments, enhances a model productionizing experience for data scientists and ML engineers, does not require MLOps expertise, provides privacy-preserving secured federated training and inference; employs a vendor-neutral platform that leverages open source solutions; and/or allows for an on-premises or multi-cloud co-located data centers for improved data proximity. The disclosed ML model processing framework can systematically incorporate engineering best practices into the development and processing of ML models.

Among other benefits, the privacy-preserving aspects of the training and inference stages, for example, enables multiple users, entities and/or organizations to collaborate with respect to training ML models without sharing raw data. The disclosed ML model processing framework platform uses privacy-preserving techniques to protect information, such as sensitive data, while allowing collective model training. Each ML engineer, in at least some embodiments, only has access to their own projects. As noted above, secrets needed to execute the ML code are kept inside user-managed vaults 880. A token to a given vault 880 may be injected to the associated container at run time.

The versatile deployment enabled by the on-premises and/or multi-cloud co-located data centers provide improved data proximity, an elastic infrastructure, improved data quality and validation and a testing and validation of ML model code.

It should also be understood that the disclosed techniques for processing ML models in an ML pipeline using virtual resources and vault-based credentials can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for ML pipeline processing may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based ML pipeline processing engine, or portions thereof, are illustratively implemented for use by tenants of such a multi-tenant environment.

Cloud infrastructure as disclosed herein can include cloud-based systems. Virtual machines provided in such systems can be used to implement at least portions of an ML pipeline processing platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container. The containers may run on virtual machines in a multi-tenant environment, although other arrangements are possible. The containers may be utilized to implement a variety of different types of functionalities within the storage devices. For example, containers can be used to implement respective processing devices providing compute services of a cloud-based system. Again, containers may be used in combination with other virtualization infrastructure such as virtual machines implemented using a hypervisor.

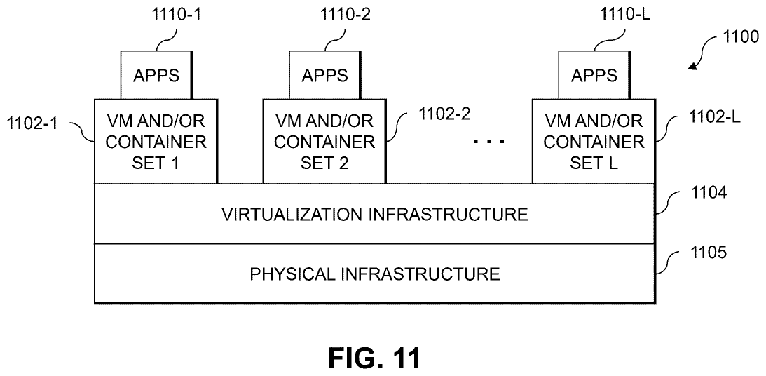

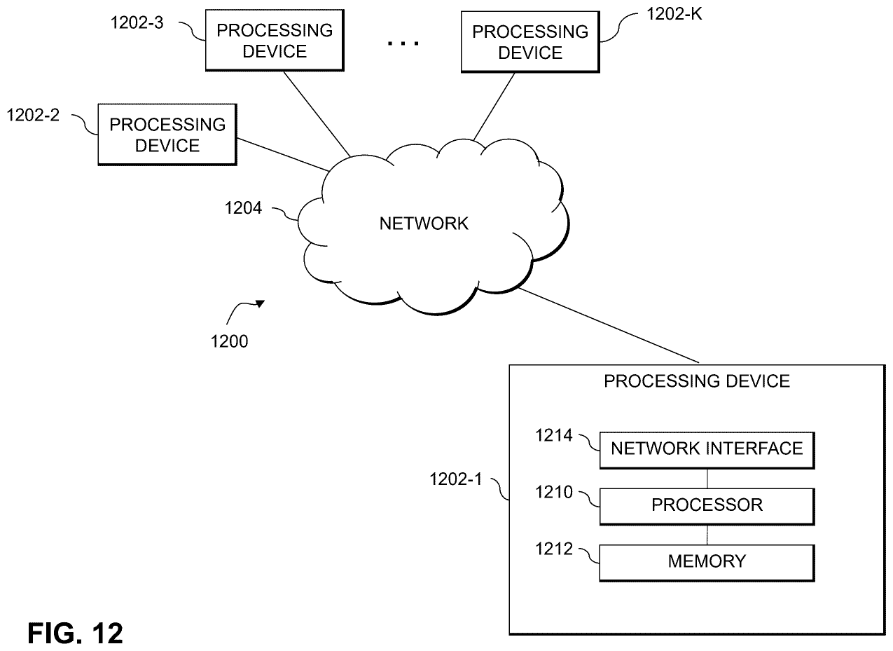

Illustrative embodiments of processing platforms will now be described in greater detail with reference to FIGS. 11 and 12. These platforms may also be used to implement at least portions of other information processing systems in other embodiments.

FIG. 11 shows an example processing platform comprising cloud infrastructure 1100. The cloud infrastructure 1100 comprises a combination of physical and virtual processing resources that may be utilized to implement at least a portion of the information processing system 100. The cloud infrastructure 1100 comprises multiple VMs and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

The cloud infrastructure 1100 further comprises sets of applications 1110-1, 1110-2, . . . 1110-L running on respective ones of the VMs/container sets 1102-1, 1102-2, . . . 1102-L under the control of the virtualization infrastructure 1104. The VMs/container sets 1102 may comprise respective VMs, respective sets of one or more containers, or respective sets of one or more containers running in VMs.

In some implementations of the FIG. 11 embodiment, the VMs/container sets 1102 comprise respective VMs implemented using virtualization infrastructure 1104 that comprises at least one hypervisor. Such implementations can provide ML pipeline processing functionality of the type described above for one or more processes running on a given one of the VMs. For example, each of the VMs can implement ML pipeline processing control logic and associated credential processing functionality for one or more processes running on that particular VM.

A hypervisor platform used to implement a hypervisor within the virtualization infrastructure 1104 may have an associated virtual infrastructure management system. The underlying physical machines may comprise one or more distributed processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system. Such implementations can provide ML pipeline processing functionality of the type described above for one or more processes running on different ones of the containers. For example, a container host device supporting multiple containers of one or more container sets can implement one or more instances of ML pipeline processing control logic and associated credential processing functionality.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1200 shown in FIG. 12.

The processing platform 1200 in this embodiment comprises at least a portion of the given system and includes a plurality of processing devices, denoted 1202-1, 1202-2, 1202-3, . . . 1202-K, which communicate with one another over a network 1204. The network 1204 may comprise any type of network, such as a WAN, a LAN, a satellite network, a telephone or cable network, a cellular network, a wireless network such as WiFi or WiMAX, or various portions or combinations of these and other types of networks.

The processing device 1202-1 in the processing platform 1200 comprises a processor 1210 coupled to a memory 1212. The processor 1210 may comprise a microprocessor, a microcontroller, an ASIC, an FPGA, a CPU, a GPU, a TPU, a VPU, a NPU, a DPU, a SOC or other type of processing circuitry, as well as portions or combinations of such circuitry elements, and the memory 1212, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 11 or 12, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining a request from a user to process at least one machine learning (ML) model in a given stage of a plurality of stages of an ML pipeline;
obtaining an ML pipeline template to configure at least one virtual computing resource;
obtaining a namespace associated with the user, wherein the namespace comprises model code for the at least one ML model, at least one artifact of the at least one ML model and one or more credentials of the user stored in a secure digital vault;
configuring the at least one virtual computing resource using the ML pipeline template and the at least one artifact of the at least one ML model;
initiating an execution of at least a portion of the model code for the at least one ML model by the configured at least one virtual computing resource, wherein the execution of the model code for the at least one ML model comprises accessing at least one protected resource using at least one of the one or more credentials of the user obtained from the secure digital vault;
obtaining one or more results from the execution of the at least the portion of the model code for the at least one ML model by the configured at least one virtual computing resource; and
initiating one or more processing steps based at least in part on at least one of the one or more results;
wherein the method is performed by at least one processing device comprising a processor coupled to a memory.

2. The method of claim 1, further comprising providing a graphical user interface to present a visual representation of at least some of the plurality of stages of the ML pipeline to the user for selection of a given ML model to execute.

3. The method of claim 1, further comprising initiating a debugging of at least a portion of the at least one ML model using the one or more results from the execution of the at least the portion of the model code for the at least one ML model.

4. The method of claim 1, further comprising processing at least one configuration file associated with the at least one ML model to identify one or more software dependencies for an execution of the at least the portion of the model code for the at least one ML model; and installing the one or more identified software dependencies for the execution of the at least the portion of the model code on the configured at least one virtual computing resource.

5. The method of claim 1, further comprising obtaining configuration information for the ML pipeline from the user and updating at least a portion of the namespace associated with the user using the obtained configuration information.

6. The method of claim 1, wherein the obtaining the one or more results from the execution of the at least the portion of the model code for the at least one ML model further comprises one or more of: providing the one or more results to the user in a first execution mode and storing the one or more results in at least one database in a second execution mode.

7. The method of claim 1, wherein the request specifies data to be applied to the at least one ML model during the execution of the at least the portion of the model code for the at least one ML model by the configured at least one virtual computing resource.

8. The method of claim 1, wherein the request from the user to process the at least one ML model comprises one or more of a request to train the at least one ML model and a request for the at least one ML model to generate one or more predictions.

9. The method of claim 1, wherein the ML pipeline template defines a generic configuration of the at least one virtual computing resource and wherein the at least one artifact of the at least one ML model comprises model-specific modifications to the generic configuration of the at least one virtual computing resource.

10. The method of claim 1, further comprising implementing a plurality of the configured at least one virtual computing resource in parallel, and wherein a given instance of the at least one ML model is trained on a given configured virtual computing resource using a respective set of training data to generate a respective trained ML model that generates a respective prediction using a respective set of inference data.

11. The method of claim 10, further comprising aggregating the respective predictions from the plurality of trained ML models into an aggregate prediction.

12. The method of claim 1, wherein the one or more processing steps comprise at least one of: generating a notification for approval of the at least one result, publishing the at least one result and causing an action to be performed in another system using the at least one result.

13. An apparatus comprising:
at least one processing device comprising a processor coupled to a memory;
the at least one processing device being configured to implement the following steps:
obtaining a request from a user to process at least one machine learning model (ML) in a given stage of a plurality of stages of an ML pipeline;
obtaining an ML pipeline template to configure at least one virtual computing resource;
obtaining a namespace associated with the user, wherein the namespace comprises model code for the at least one ML model, at least one artifact of the at least one ML model and one or more credentials of the user stored in a secure digital vault;
configuring the at least one virtual computing resource using the ML pipeline template and the at least one artifact of the at least one ML model;
initiating an execution of at least a portion of the model code for the at least one ML model by the configured at least one virtual computing resource, wherein the execution of the model code for the at least one ML model comprises accessing at least one protected resource using at least one of the one or more credentials of the user obtained from the secure digital vault;
obtaining one or more results from the execution of the at least the portion of the model code for the at least one ML model by the configured at least one virtual computing resource; and
initiating one or more processing steps based at least in part on at least one of the one or more results.

14. The apparatus of claim 13, further comprising processing at least one configuration file associated with the at least one ML model to identify one or more software dependencies for an execution of the at least the portion of the model code for the at least one ML model; and installing the one or more identified software dependencies for the execution of the at least the portion of the model code on the configured at least one virtual computing resource.

15. The apparatus of claim 13, wherein the ML pipeline template defines a generic configuration of the at least one virtual computing resource and wherein the at least one artifact of the at least one ML model comprises model-specific modifications to the generic configuration of the at least one virtual computing resource.

16. The apparatus of claim 13, further comprising implementing a plurality of the configured at least one virtual computing resource in parallel, and wherein a given instance of the at least one ML model is trained on a given configured virtual computing resource using a respective set of training data to generate a respective trained ML model that generates a respective prediction using a respective set of inference data.

17. A non-transitory processor-readable storage medium having stored therein program code of one or more software programs, wherein the program code when executed by at least one processing device causes the at least one processing device to perform the following steps:
obtaining a request from a user to process at least one machine learning (ML) model in a given stage of a plurality of stages of an ML pipeline;
obtaining an ML pipeline template to configure at least one virtual computing resource;
obtaining a namespace associated with the user, wherein the namespace comprises model code for the at least one ML model, at least one artifact of the at least one ML model and one or more credentials of the user stored in a secure digital vault;
configuring the at least one virtual computing resource using the ML pipeline template and the at least one artifact of the at least one ML model;
initiating an execution of at least a portion of the model code for the at least one ML model by the configured at least one virtual computing resource, wherein the execution of the model code for the at least one ML model comprises accessing at least one protected resource using at least one of the one or more credentials of the user obtained from the secure digital vault;
obtaining one or more results from the execution of the at least the portion of the model code for the at least one ML model by the configured at least one virtual computing resource; and
initiating one or more processing steps based at least in part on at least one of the one or more results.

18. The non-transitory processor-readable storage medium of claim 17, further comprising processing at least one configuration file associated with the at least one ML model to identify one or more software dependencies for an execution of the at least the portion of the model code for the at least one ML model; and installing the one or more identified software dependencies for the execution of the at least the portion of the model code on the configured at least one virtual computing resource.

19. The non-transitory processor-readable storage medium of claim 17, wherein the ML pipeline template defines a generic configuration of the at least one virtual computing resource and wherein the at least one artifact of the at least one ML model comprises model-specific modifications to the generic configuration of the at least one virtual computing resource.

20. The non-transitory processor-readable storage medium of claim 17, further comprising implementing a plurality of the configured at least one virtual computing resource in parallel, and wherein a given instance of the at least one ML model is trained on a given virtual configured computing resource using a respective set of training data to generate a respective trained ML model that generates a respective prediction using a respective set of inference data.
